(19) United States
(12) Patent Application Publication
(10) Pub. No.: US 2022/0066258 A1
(43) Pub. Date: Mar. 3, 2022

(54) LIQUID CRYSTAL DISPLAY DEVICE

(71) Applicant: TPK Advanced Solutions Inc., Xiamen (CN)

(72) Inventors: So Haeng Cho, Taipei City (TW); Sang Jin Kim, New Taipei City (TW); Cheng Ping Liu, Taoyuan City (TW); Yan Fei He, Ganzhou City (CN)

(21) Appl. No.: 17/007,207

(22) Filed: Aug. 31, 2020

(51) Int. Cl. G02F 1/1333

(52) U.S. Cl. CPC G02F 1/133382; G02F 2201/50; G02F 2202/28; G02F 1/13338

(57) ABSTRACT

A liquid crystal display device includes a display module, a functional layer, and a heating module. The display module has a display surface. The functional layer is disposed at one side of the display surface of the display module. The heating module is disposed corresponding to the display module. The liquid crystal display device can solve the phenomenon of liquid crystal hysteresis caused by low-temperature environments.

### BACKGROUND

### Technology Field

The present disclosure relates to an electronic device and, in particular, to a liquid crystal display device that can avoid image sticking and slow frame problems.

### Description of Related Art

With the progress of technology, flat display devices, especially liquid crystal display devices, have been widely used in various fields, which have gradually replaced traditional cathode-ray tube (CRT) display devices due to advances that have enabled the devices to be light, have a thin body, have low power consumption, and emit no radiation. Accordingly, the liquid crystal display devices have been applied to many types of electronic products, such as mobile phones, portable multimedia devices, laptop computers, liquid crystal display (LCD) televisions (TVs), and LCD screens.

Compared with room temperature or warm environments, liquid crystal molecules of the liquid crystal display devices will cause a hysteresis phenomenon in a low temperature environment (e.g. below 0° C.), so that the response time of the liquid crystal molecules in the low temperature environment becomes several times slower than that at normal temperatures, which may cause problems such as image sticking and slow frame. Accordingly, the liquid crystal display devices may not be used in frigid regions or polar regions, especially in low-temperature outdoor environments.

### SUMMARY

In view of the foregoing, an objective of this disclosure is to provide a liquid crystal display device that can eliminate the liquid crystal hysteresis phenomenon caused by low temperature environments, thereby avoiding the image sticking and slow frame problems.

To achieve the above, the present disclosure provides a liquid crystal display device, which comprises a display module, a functional layer, and a heating module. The display module has a display surface, and the functional layer is disposed at one side of the display surface of the display module. The heating module is disposed corresponding to the display module.

In one embodiment, the functional layer is an anti-glare film, an anti-scratch film, an anti-finger printing film, a waterproof and anti-fouling film, or an anti-shatter film.

In one embodiment, the heating module comprises a substrate and a heating layer, the substrate has a first surface and a second surface opposite to the first surface, and the heating layer is disposed on at least one of the first surface or the second surface of the substrate.

In one embodiment, a sheet resistance of the heating layer is greater than 0 and is less than or equal to 30 ohm/square.

In one embodiment, a material of the heating layer comprises silver nanowire (SNW), indium tin oxide (ITO), indium zinc oxide (IZO), metal mesh, carbon nanotube (CNT), graphene, or conductive metal thin film.

In one embodiment, the heating module further comprises two electrodes, and the electrodes are disposed at two opposite sides of the substrate and electrically connected to the heating layer.

In one embodiment, the heating module is disposed between the functional layer and the display module.

In one embodiment, the liquid crystal display device further comprises a touch panel disposed between the functional layer and the heating module.

In one embodiment, the liquid crystal display device further comprises a protection cover disposed between the functional layer and the touch panel.

In one embodiment, the liquid crystal display device further comprises a first adhesion layer and a second adhesion layer. The first adhesion layer is disposed between the touch panel and the heating module, and the second adhesion layer is disposed between the heating module and the display module.

In one embodiment, the liquid crystal display device further comprises a touch pattern layer. The heating module comprises a substrate and a heating layer, the substrate has two surfaces opposite to each other, the touch pattern layer is disposed on one of the two surfaces, and the heating layer is disposed on the other one of the two surfaces.

In one embodiment, the liquid crystal display device further comprises a protection cover disposed between the functional layer and the touch pattern layer.

In one embodiment, the liquid crystal display device further comprises a display panel and a backlight unit. The heating module is disposed between the display panel and the backlight unit, or the heating module is disposed at one side or on one surface of the backlight unit away from the display panel.

In one embodiment, the liquid crystal display device further comprises a touch panel disposed between the functional layer and the display panel.

In one embodiment, the heating module is disposed at one side or on one surface of the display module away from the display surface.

As mentioned above, when the liquid crystal display device of this disclosure is within a low temperature environment, the heating module can generate heat within a short time and transmit the heat energy to the liquid crystal molecules of the display module (or the display panel), thereby heating the display module (or the display panel) to the normal operation temperature (e.g. 20-30° C. or more) within a short time. Accordingly, this disclosure can prevent the liquid crystal hysteresis phenomenon caused by the low temperature environment, thereby avoiding the image sticking and slow frame problems.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a schematic diagram showing a liquid crystal display device according to an embodiment of this disclosure;

FIG. 1B is a sectional view of a heating module in the liquid crystal display device as shown in FIG. 1A along the line A-A;

FIGS. 2, 3A, 4, and 5 are schematic diagrams showing the liquid crystal display devices according to different embodiments of this disclosures; and

FIG. 3B is a sectional view of a heating module in the liquid crystal display device as shown in FIG. 3A along the line B-B.

### DETAILED DESCRIPTION OF THE DISCLOSURE

The present disclosure will be apparent from the following detailed description, which proceeds with reference to the accompanying drawings, wherein the same references relate to the same elements.

The liquid crystal display device of this disclosure can be, for example but not limitation, an FFS (Fringe Filed Switching) type liquid crystal display device, an IPS (In Plane Switching) type liquid crystal display device, a TN (Twisted Nematic) type liquid crystal display device, a VA (Vertical Alignment) type liquid crystal display device, or any of other type of liquid crystal display devices. Therefore, this disclosure is not limited to a particular type(s) of liquid crystal display devices.

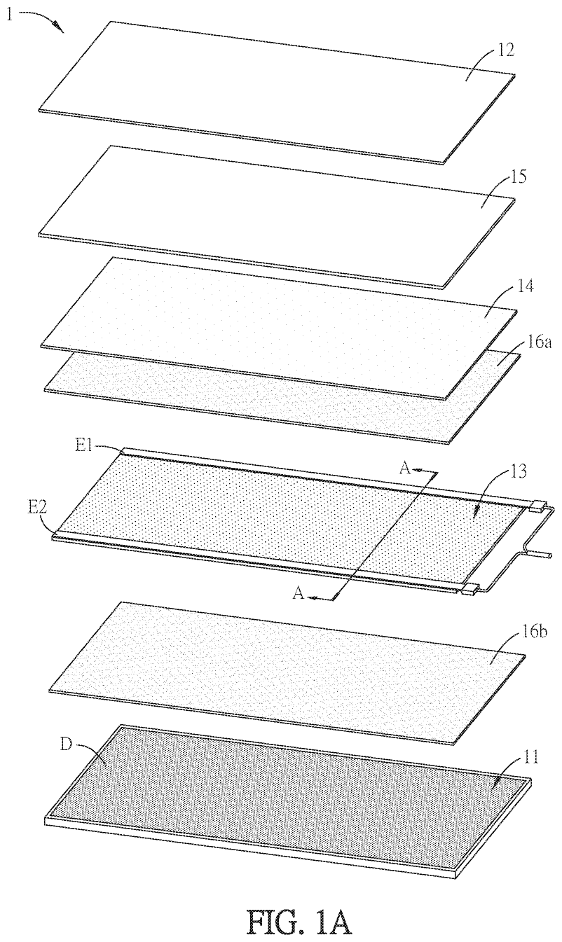

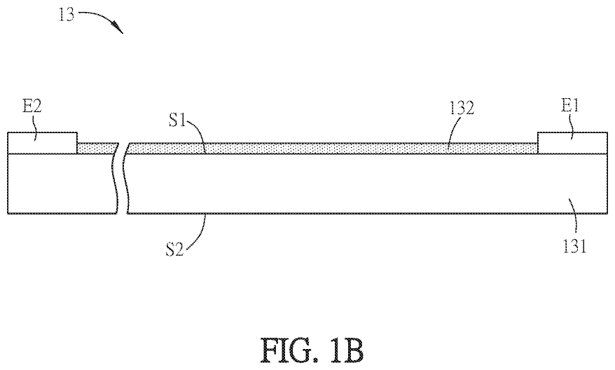

FIG. 1A is a schematic diagram showing a liquid crystal display device 1 according to an embodiment of this disclosure, and FIG. 1B is a sectional view of a heating module 13 in the liquid crystal display device 1 as shown in FIG. 1A along the line A-A.

Referring to FIG. 1A, the liquid crystal display device 1 comprises a display module 11, a functional layer 12, and the heating module 13. In addition, the liquid crystal display device 1 can further comprise a touch panel 14, a protection cover 15, a first adhesion layer 16a, and a second adhesion layer 16b.

The display module 11 has a display surface D, and the functional layer 12 is disposed at one side or on one surface of the display surface D of the display module 11. In this embodiment, the display surface D can display the images, and the functional layer 12 is located on or above the display module 11 and is disposed corresponding to the display surface D. The display module 11 can be a liquid crystal display module (LCM), which includes liquid crystal molecules. The functional layer 12 can be a transparent film such as, for example but not limitation, an anti-glare film, an anti-scratch film, an anti-finger printing film, a waterproof and anti-fouling film, or an anti-shatter film. The type or function of the functional layer 12 is not intended to be limited by the instant disclosure.

The heating module 13 is disposed on the display module 11. The heating module 13 is configured to heat the display module 11 to increase the temperature of (the liquid crystal molecules of) the display module 11. The heating module 13 of this embodiment is disposed between the functional layer 12 and the display module 11. As shown in FIG. 1B, the heating module 13 comprises a substrate 131 and a heating layer 132. The substrate 131 has a first surface Si and a second surface S2 opposite to the first surface S1, and the heating layer 132 is disposed on the first surface S1 and/or the second surface S2 of the substrate 131. In this case, the first surface S1 faces toward the functional layer 12, and the second surface S2 faces toward the display module 11. In this embodiment, the heating layer 132 is, for example, disposed on the first surface S1 of the substrate 131. The substrate 131 can be a transparent insulation substrate such as, for example but not limitation, a glass substrate or a PI (Polyimide) substrate. The heating layer 132 is light permeable and comprises a resistance material, so that the heating layer 132 can generate heat energy after a current is applied thereto. The resistance material can comprise silver nanowire (SNW), indium tin oxide (ITO), indium zinc oxide (IZO), metal mesh, carbon nanotube (CNT), graphene, conductive metal thin film, any other resistance material, or their combinations.

In some embodiments, the sheet resistance of the heating layer 132 can be greater than 0 and is less than or equal to 30 ohm/square (0<sheet resistance>30 ohm/sq.), such as, for example but not limitation, 5.2, 8, 10, 17, 20, 22, or 28.5 ohm/sq. To be noted, among the above-mentioned resistance materials, the conductive metal thin film has excellent electrical conductivity, heat resistance, and durability, so that the heating layer 132 made of the conductive metal thin film can have a lower resistance value. As a result, the conductive metal thin film can further improve the heating efficiency and is more suitable as a material for the heating layer 132.

In addition, the heating module 13 of this embodiment can further comprise two electrodes E1 and E2. The electrodes E1 and E2 are disposed on the first surface S1 of the substrate 131, and are located at two opposite sides of the first surface S1, respectively, and electrically connected to the heating layer 132. In this embodiment, the material of the electrodes E1 and E2 can be, for example but not limitation, copper, silver, or their combination. The electrodes E1 and E2 can be formed on the substrate 131 by coating, printing, stamping, transferring, or the likes, and the electrodes E1 and E2 are located at two opposite sides of the heating layer 132, respectively. Accordingly, when a voltage gap is applied to the two electrodes E1 and E2, the resistance material of the heating layer 132 can generate heat energy, which can be transferred to the display module 11 for heating the liquid crystal molecules of the display module 11. Therefore, the temperature of the liquid crystal molecules of the display module 11 can be increased to the normal operation temperature within a short time (e.g. 2-5 minutes), thereby preventing the liquid crystal hysteresis phenomenon caused by the low temperature environment.

Referring to FIG. 1A, the touch panel 14 is disposed between the functional layer 12 and the heating module 13. In this embodiment, the touch panel 14 is disposed above the display module 11 and is located between the functional layer 12 and the heating module 13. In some embodiments, the touch panel 14 comprises a substrate and a touch pattern layer, and the touch pattern layer is disposed on the substrate. The touch pattern layer can define the touch sensing circuit (i.e. the driving electrodes Tx and the sensing electrodes Rx). The touch pattern layer can be used to sense the touch position of the user, so that the liquid crystal display device 1 can be modified into an out-cell touch display device.

The protection cover 15 can be a transparent protection glass such as, for example but not limitation, a transparent glass. The protection cover 15 is disposed between the functional layer 12 and the touch panel 14. In this embodiment, the functional layer 12 is disposed on one surface of the protection cover 15 away from the touch panel 14. The protection cover 15 is configured to protect the touch panel 14, the heating module 13, and the display module 11 from the invasion of other external substances or moisture.

The first adhesion layer 16a is disposed between the touch panel 14 and the heating module 13 for bonding the touch panel 14 and the heating module 13 together. The second adhesion layer 16b is disposed between the heating module 13 and the display module 11 for bonding the heating module 13 and the display module 11 together. The first adhesion layer 16a or the second adhesion layer 16b can be, for example but not limitation, an optical clear adhesive (OCA), an optical clear resin (OCR), and any of other transparent adhesives.

As mentioned above, in the liquid crystal display device 1 of this embodiment, the functional layer 12 is disposed at one side or on one surface of the display surface D of the display module 11, and the heating module 13 is disposed between the display module 11 and the functional layer 12. Accordingly, when the liquid crystal display device 1 is positioned in a low temperature environment, a voltage gap can be applied to the two electrodes E1 and E2 of the heating module 13 for enabling the heating layer 132 of the heating module 13 to generate heat energy. The generated heat energy can be transferred to the display module 11 for increasing the temperature of the display module 11 to the normal operation temperature (e.g. 20-30° C. or more) within a short time. This configuration can prevent the liquid crystal hysteresis phenomenon caused by the low temperature environment, thereby avoiding the image sticking and slow frame problems.

In one experiment for the heating module 13 of a 10.25 inch product (length 257 mm by width 105 mm), wherein the heating layer 132 is made of SNW and the sheet resistance thereof is 20 ohm/sq. for example, when the applied voltage gap is 19V, the temperature of the heating module 13 increases 9.4° C. after 15 seconds, or increases 36.4° C. after 3 minutes, or increases 36.1° C. after 10 minutes. In another heating test for the heating module 13 of a 10.25 inch product (length 257 mm by width 105 mm), wherein the heating layer 132 is made of metal mesh and the sheet resistance thereof is 10 ohm/sq. for example, when the applied voltage gap is 7V, the temperature of the heating module 13 increases 30° C. after 210 seconds; or when the applied voltage gap is 12V, the temperature of the heating module 13 increases 50° C. after 210 seconds. This experiment proved that the heating layer 132 of the heating module 13 can generate heat energy quickly for heating the display module 11. Accordingly, the temperature of the liquid crystal molecules can be increased to the normal operation temperature within a short time, thereby preventing the liquid crystal hysteresis phenomenon caused by the low temperature environment.

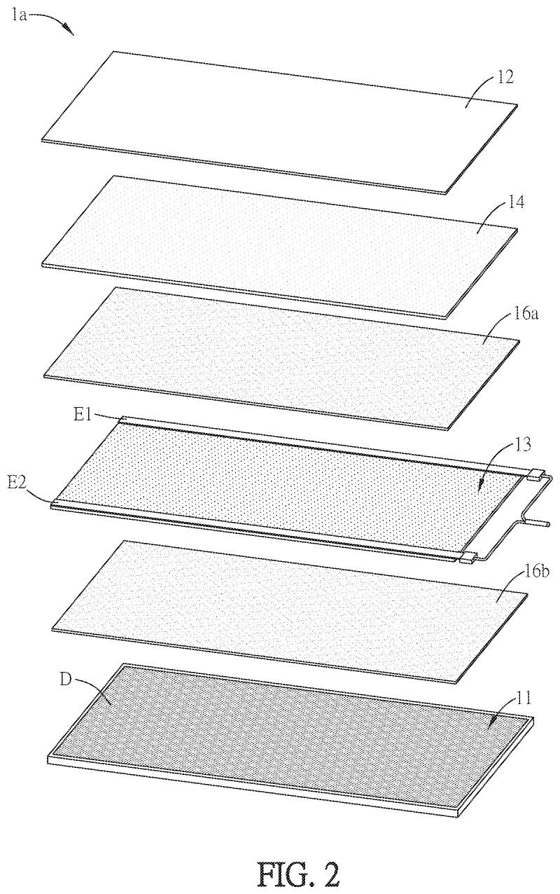

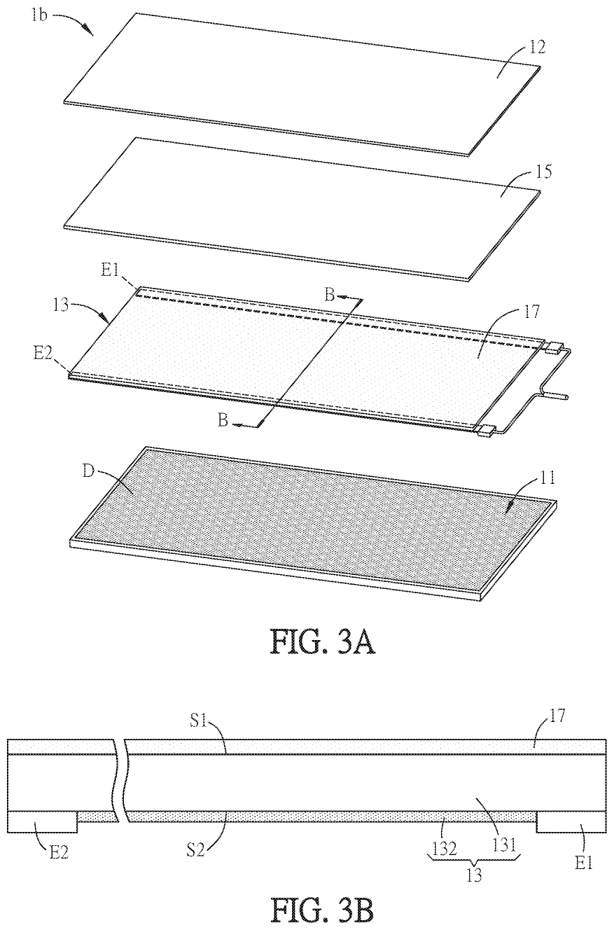

FIGS. 2, 3A, 4, and 5 are schematic diagrams showing liquid crystal display devices 1a-1d according to different embodiments of this disclosures, and FIG. 3B is a sectional view of a heating module 13 in the liquid crystal display device 1b as shown in FIG. 3A along the line B-B.

As shown in FIG. 2, the element components and element connections of the liquid crystal display device la of this embodiment are mostly the same as those of the liquid crystal display device 1 of the previous embodiment. Different from the previous embodiment, the liquid crystal display device 1a of this embodiment does not include the protection cover 15. In this embodiment, (the substrate of) the touch panel 14 also functions as a protection cover, so that the liquid crystal display device 1a is manufactured as an OGS (One Glass Solution) touch display device. Accordingly, the functional layer 12 of this embodiment can be disposed on the surface of the heating module 13 away from the touch panel 14, and the touch pattern layer of the touch panel 14 is disposed facing toward the heating module 13.

As shown in FIGS. 3A and 3B, the element components and element connections of the liquid crystal display device 1b of this embodiment are mostly the same as those of the liquid crystal display device 1 of the previous embodiment. Different from the previous embodiment, the liquid crystal display device 1b of this embodiment includes a touch pattern layer 17 instead of the touch panel 14. Referring to FIG. 3B, the heating module 13 comprises a substrate 131 and a heating layer 132. The substrate 131 has a first surface S1 and a second surface S2. The first surface S1 faces toward the protection cover 15, and the second surface S2 faces toward the display module 11. The touch pattern layer 17 is disposed on the first surface S1 of the substrate 131, and the protection cover 15 is located between the functional layer 12 and the touch pattern layer 17. The heating layer 132 and the electrodes E1 and E2 are disposed on the second surface S2 of the substrate 131. In other embodiments, the touch pattern layer 17 can be disposed on the second surface S2 of the substrate 131, and the heating layer 132 and the electrodes E1 and E2 are disposed on the first surface S1 of the substrate 131. This disclosure is therefore not limited to a particular configuration.

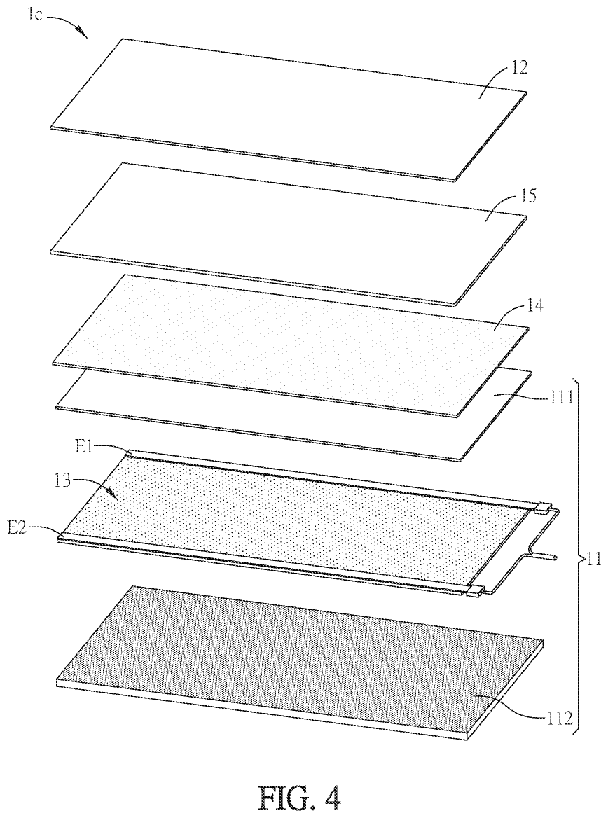

As shown in FIG. 4, the element components and element connections of the liquid crystal display device 1c of this embodiment are mostly the same as those of the liquid crystal display device 1 of the previous embodiment. Different from the previous embodiment, the liquid crystal display device 1c of this embodiment does not include the first adhesion layer 16a and the second adhesion layer 16b. Moreover, the heating module 13 is disposed inside the display module 11 instead of at a position between the functional layer 12 and the display module 11. In this embodiment, the display module 11 comprises a display panel 111 and a backlight unit 112. The backlight unit 112 can emit light toward the display panel 111, so that the display panel 111 can display images. In addition, the touch panel 14 is disposed between the functional layer 12 (or the protection cover 15) and the display panel 111, the protection cover 15 is disposed between the functional layer 12 and the touch panel 14, and the heating module 13 is disposed between the display panel 111 and the backlight unit 112. This configuration of disposing the heating module 13 between the display panel 111 and the backlight unit 112 can also heat the liquid crystal molecules of the display panel 111, thereby preventing the liquid crystal hysteresis phenomenon caused by the low temperature environment.

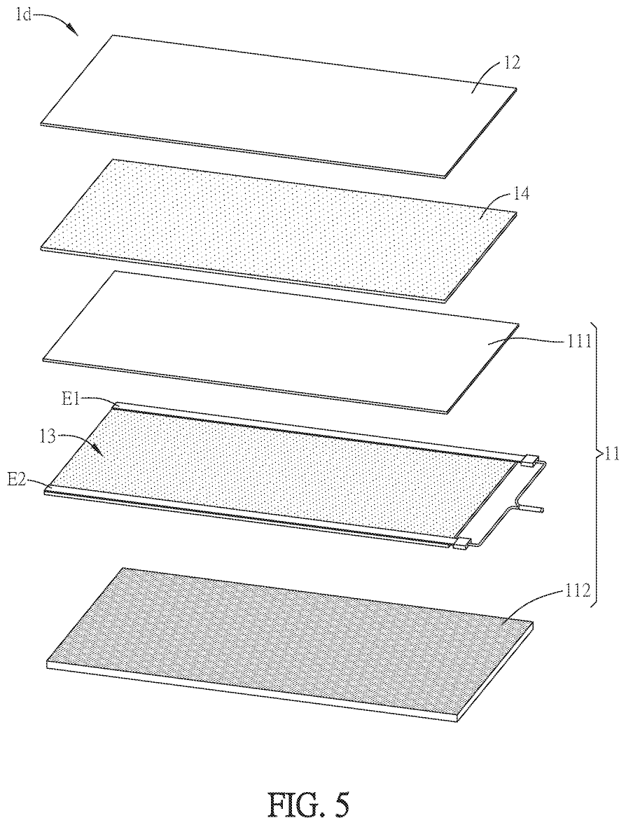

As shown in FIG. 5, the element components and element connections of the liquid crystal display device 1d of this embodiment are mostly the same as those of the liquid crystal display device 1c of the previous embodiment. Different from the previous embodiment, the liquid crystal display device 1d of this embodiment does not include the protection cover 15. In this embodiment, (the substrate of) the touch panel 14 also functions as a protection cover, so that the liquid crystal display device 1d is manufactured as an OGS (One Glass Solution) touch display device.

The other technical features of the liquid crystal display devices 1a-1d can reference the same elements as the liquid crystal display device 1, so the detailed descriptions thereof will be omitted.

In the case of disposing the heating module 13 inside the display module 11, the heating module 13 can be disposed at one side or on one surface of the backlight unit 112 away from the display panel. This configuration can also achieve the purpose of heating the liquid crystal molecules of the display panel 111. To be noted, this aspect is not shown in the drawings.

As mentioned above, in the liquid crystal display device of this disclosure, the functional layer is disposed at one side or on one surface of the display surface of the display module, and the heating module is disposed corresponding to the display module. In some embodiments, the heating module is disposed between the functional layer and the display module. In other embodiments, the heating module can be disposed between the display panel and the backlight unit of the display module. Accordingly, when the liquid crystal display device is located within a low temperature environment, the heating module can generate heat energy within a short time and transmit the heat energy to the liquid crystal molecules of the display module (or the display panel), thereby heating the display module (or the display panel) to the normal operation temperature (e.g. 20˜30° C. or more) within a short time. As a result, this disclosure can prevent the liquid crystal hysteresis phenomenon caused by the low temperature environment, thereby avoiding the image sticking and slow frame problems.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

1. A liquid crystal display device, comprising:
a display module having a display surface;
a functional layer disposed at one side of the display surface of the display module; and
a heating module disposed corresponding to the display module, wherein the heating module comprises:
a light permeable heating layer comprising silver nanowire (SNW) or graphene;
a first electrode co-planar with the light permeable heating layer; and
a second electrode co-planar with the light permeable heating layer, wherein the light permeable heating layer is disposed between the first electrode and the second electrode and electrically connected to the first electrode and the second electrode.

2. The liquid crystal display device of claim 1, wherein the functional layer is an anti-glare film, an anti-scratch film, an anti-finger printing film, a waterproof and anti-fouling film, or an anti-shatter film.

3. The liquid crystal display device of claim 1, wherein the heating module comprises a substrate, the substrate has a first surface and a second surface opposite to the first surface, and the light permeable heating layer is disposed on at least one of the first surface or the second surface of the substrate.

4. The liquid crystal display device of claim 1, wherein a sheet resistance of the light permeable heating layer is greater than 0 and is less than or equal to 30 ohm/square.

5. The liquid crystal display device of claim 1, wherein the light permeable heating layer comprises the silver nanowire (SNW).

6. The liquid crystal display device of claim 3, wherein the first electrode, the second electrode, and the light permeable heating layer are in direct contact with a same surface of the substrate.

7. The liquid crystal display device of claim 1, wherein the heating module is disposed between the functional layer and the display module.

8. The liquid crystal display device of claim 7, further comprising:
a touch panel disposed between the functional layer and the heating module.

9. The liquid crystal display device of claim 8, further comprising:
a first adhesion layer and a second adhesion layer, wherein the first adhesion layer is disposed between the touch panel and the heating module, and the second adhesion layer is disposed between the heating module and the display module.

10. The liquid crystal display device of claim 8, further comprising:
a protection cover disposed between the functional layer and the touch panel.

11. The liquid crystal display device of claim 10, further comprising:
a first adhesion layer and a second adhesion layer, wherein the first adhesion layer is disposed between the touch panel and the heating module, and the second adhesion layer is disposed between the heating module and the display module.

12. The liquid crystal display device of claim 7, further comprising:
a touch pattern layer, wherein the heating module comprises a substrate, the substrate has two surfaces opposite to each other, the touch pattern layer is disposed on one of the two surfaces, and the light permeable heating layer is disposed on the other one of the two surfaces.

13. The liquid crystal display device of claim 12, further comprising:
a protection cover disposed between the functional layer and the touch pattern layer.

14. The liquid crystal display device of claim 1, wherein the display module comprises a display panel and a backlight unit, and the heating module is disposed between the display panel and the backlight unit, or the heating module is disposed at one side of the backlight unit away from the display panel.

15. The liquid crystal display device of claim 14, further comprising:
a touch panel disposed between the functional layer and the display panel.

16. (canceled)

17. The liquid crystal display device of claim 1, wherein the heating module is disposed at one side of the display module away from the display surface.

18. The liquid crystal display device of claim 3, wherein the substrate is at least one of a glass substrate or a polyimide substrate.

19. The liquid crystal display device of claim 10, wherein the protection cover is glass.

20. (canceled)

21. A liquid crystal display device, comprising:
a display module having a display surface, wherein the display module comprises a display panel and a backlight unit;
a functional layer disposed at one side of the display surface of the display module;
a touch panel disposed between the functional layer and the display panel;
a protection cover disposed between the functional layer and the touch panel; and
a heating module disposed corresponding to the display module, wherein the heating module is disposed at one side of the backlight unit away from the display panel.

22. A liquid crystal display device, comprising:
a display module having a display surface;
a functional layer disposed at one side of the display surface of the display module;
a heating module disposed corresponding to the display module, wherein the heating module comprises:
a substrate; and
a light permeable heating layer disposed on a first surface of the substrate; and
a touch panel layer comprising at least one of driving electrodes or sensing electrodes, wherein the at least one of driving electrodes or sensing electrodes are disposed directly on the substrate of the heating module.
